(19) United States
(12) Patent Application Publication
(10) Pub. No.: US 2019/0122275 A1
(43) Pub. Date: Apr. 25, 2019

(54) METHOD OF DETERMINING PACKABILITY OF PRODUCT CONTEMPLATED FOR PURCHASE RELATIVE TO VEHICLE INTENDED FOR TRANSPORTING THE CONTEMPLATED PRODUCT

(71) Applicant: MASTERCARD INTERNATIONAL INCORPORATED, Purchase, NY (US)

(72) Inventors: Matthieu Goffin, Ecaussinnes (BE); Mathias Gerard, Court-Saint-Etienne (BE); Samuel Hirsoux, Gouy-Lez-Pièton (BE)

(21) Appl. No.: 15/790,980

(22) Filed: Oct. 23, 2017

(51) Int. Cl. G06Q 30/06; G06Q 20/12

(52) U.S. Cl. CPC G06Q 30/0613; G06F 3/04842; G06Q 20/12

(57) ABSTRACT

In one aspect, a method is provided of determining the packability of product contemplated for purchase with respect to a vehicle intended for transporting the contemplated product. The method includes receiving one or more selections of the contemplated product, the vehicle intended for transporting the contemplated product, and the number of passengers under consideration to be in the intended vehicle. The method further includes extracting data regarding the size of packaging associated with the contemplated product and data regarding dimensioning of the intended vehicle. Stored instructions are executed to cause calculation of the packability of the contemplated product in the associated packaging with respect to the intended vehicle based on the extracted data and the number of intended passengers. One or more scenarios are yielded of arranging the contemplated product in the associated packaging relative to the intended vehicle and relative to the number of intended passengers.

### BACKGROUND OF THE INVENTION

Transportation of purchased product by consumers can be problematic, particularly where large-sized, bulky items are involved, such as furniture, home furnishings, etc. This issue may be exasperated by not appreciating the size, weight and weight distribution of the purchased product in a packaged, “ready for pick up” state. Little to no information may be made available or deduced from floor models or displays of the target product. Problems may follow in packing a vehicle, particularly due to dimensional and passenger constraints. This may lead to multiple trips and/or the need for one or more additional vehicles.

### SUMMARY OF THE INVENTION

In one aspect, a method is provided herein of determining the packability of at least one product contemplated for purchase with respect to a vehicle intended for transporting the at least one contemplated product. The method includes receiving, by a computer processor, one or more selections of the at least one contemplated product, the vehicle intended for transporting the at least one contemplated product, and the number of passengers under consideration to be in the intended vehicle while transporting the at least one contemplated product. The method further includes extracting from a first database, first data regarding size of packaging associated with the at least one contemplated product, and extracting from a second database, second data regarding dimensioning of the intended vehicle. Instructions stored in a non-transitory memory are caused to be executed, wherein the execution of the instructions calculates the packability of the at least one contemplated product in the associated packaging with respect to the intended vehicle based on the first data, the second data and the number of passengers under consideration to be in the intended vehicle while transporting the at least one contemplated product. The execution of the instructions further selectively yields one or more scenarios of arranging the at least one contemplated product in the associated packaging relative to the intended vehicle and relative to the number of passengers under consideration to be in the intended vehicle while transporting the at least one contemplated product. A message is displayed selectively conveying the one or more scenarios. Advantageously, the method of the subject invention allows for a consumer to evaluate the packability of product relative to a vehicle, even prior to purchase of the product.

In a further aspect, a method is provided herein of determining the packability of at least one product contemplated for purchase with respect to a vehicle intended for transporting the at least one contemplated product. The method includes receiving, by a computer processor, one or more selections of the at least one contemplated product, the vehicle intended for transporting the at least one contemplated product, and the number of passengers under consideration to be in the intended vehicle while transporting the at least one contemplated product. The method further includes extracting from a first database, first data regarding size of packaging associated with the at least one contemplated product, and extracting from a second database, second data regarding dimensioning of the intended vehicle. Instructions stored in a non-transitory memory are caused to be executed, wherein the execution of the instructions calculates the packability of the at least one contemplated product in the associated packaging with respect to the intended vehicle based on the first data, the second data and the number of passengers under consideration to be in the intended vehicle while transporting the at least one contemplated product. The execution of the instructions further selectively yields: 1. one or more scenarios of arranging the at least one contemplated product in the associated packaging relative to the intended vehicle and relative to the number of passengers under consideration to be in the intended vehicle while transporting the at least one contemplated product; and, 2. one or more alternate scenarios for transporting the at least one contemplated product in the associated packaging based on one or more of: a number of passengers other than the number of passengers under consideration to be in the intended vehicle, and, one or more vehicles other than the intended vehicle. A message is displayed selectively conveying the one or more scenarios and the one or more alternate scenarios. Advantageously, the method of the subject invention allows for a consumer to evaluate the packability of product relative to a vehicle, even prior to purchase of the product.

These and other features of the invention will be better understood through a study of the following detailed description and accompanying drawings.

### BRIEF DESCRIPTION OF THE DRAWINGS

FIG. 1 is a schematic of a system in accordance with the subject invention.

FIG. 2 is a representation of first data structures in accordance with the subject invention.

FIG. 3 is a representation of possible locating a packaged product's center of gravity in accordance with the subject invention.

FIG. 4 is a representation of second data structures in accordance with the subject invention.

### DETAILED DESCRIPTION OF THE INVENTION

A method is provided herein for determining the packability of at least one product contemplated for purchase with respect to one or more vehicles intended for transporting the at least one contemplated product. The method is useable over various networks and is particularly well suited to utilize the infrastructure of the Internet.

As used herein, the term “packability” refers to the feasibility of packing certain volumes relative to fixed-dimension area(s) and/or volume(s). For example, packability may take into consideration the dimensions of a packaged product to determine its feasibility to be transported by a particular vehicle. This evaluation not only takes into consideration the dimensions of the packaged product, but also takes into consideration, the dimensioning of the vehicle (e.g., back seat area/volume, trunk space area/volume, car roof area) and the number of intended passengers. The packability determination may yield various scenarios for packing packaged product(s) in and/or on an intended vehicle for transportation. As a further consideration, “packability” may take the weight and weight distribution (e.g., the center of gravity) of the packaged product(s) into consideration relative to the vehicle's dimensioning and intended number of passengers. In this manner, damage from weight distribution and the shifting of product during transportation may be minimized.

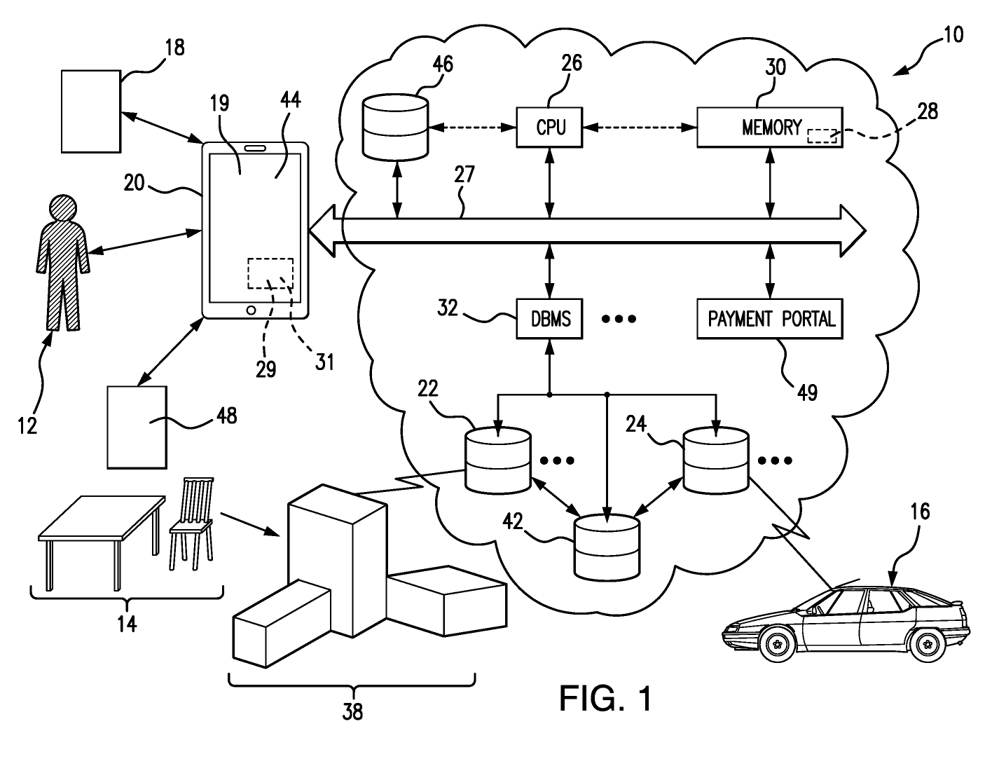

With reference to FIG. 1, the subject invention provides a system 10 which allows for a consumer 12 to evaluate the packability of one or more products 14 being considered for purchase by the consumer 12 relative to at least one vehicle 16 intended for transporting the one or more products 14. The system 10 generally includes at least one graphical user interface (GUI) 18, for accepting inputs and displaying results, displayable on a networkable device 20, e.g., screen 19. The system 10 also includes a first database 22, a second database 24, and a central computer processing unit 26 having computer instructions 28 associated therewith at least partially stored in a non-transitory electronic memory 30 which may be in any medium (RAM, ROM, disk, hard drive, flash drive, CD, optical disk, magnetic tape, etc.). The components of the system 10 may be located on one or more computing processing units linked, in part or in entirety, over a network 27, such as, the Internet, virtual private networks, wide area networks, and/or local area networks. As will be appreciated by those skilled in the art, any known equipment and arrangements may be utilized for networking.

The networkable device 20 may be any device configured with hardware (e.g., transmitter, receiver, etc.) to connect with the network 27, including the Internet, through a wired or wireless connection. The networkable device 20 may be, but not limited to, a mobile device (e.g., smartphone), tablet, pad, desktop computer, and laptop. Application or client software 29 may be provided to generate the GUI 18 and to allow for interfacing with the other components of the system 10. The application software 29 may be in any form (e.g., computer code, computer program, script) which is downloadable to the networkable device 20, particularly from the network 27 for storage on a non-transitory memory 31 associated with the networkable device 20.

The GUI 18 may be created by the application software 29 using any known programming, including, but not limited to, Java, Python, C#, C++, HTML, and Visual Basic. The application software 29 and the computer instructions 28 may transmit data therebetween and otherwise interact over the network 27 using calls, e.g., API calls, or the equivalent.

The first and second databases 22, 24 may be separately or jointly maintained, in whole or in part, on the network 27, including on the networkable device 20 and/or remotely therefrom. With the first and second databases 22, 24 being remotely located from the networkable device 20, cloud computing may be relied upon for maintenance, updating, querying, and extracting from identified database data structures. As used herein, “cloud computing” references a computing infrastructure and software model which enables access to shared pools of resources (networks, servers, storage, applications, software and services), including, but not limited to, private cloud computing, public cloud computing, hybrid (private/public) cloud computing, distributed cloud computing, intercloud computing, and multicloud computing. For example, the networkable device 20 may interact with the central processing unit 26 over the network 27 allowing for distributed processing.

At least one database management system 32 may be provided on the network 27 to accept search requests, e.g., from the networkable device 20 and/or the central processing unit 26, and to develop search queries of the first and/or second databases 22, 24 based on the search requests. Separate database management systems 32 may be provided for the first and second databases 22, 24. The first and second databases 22, 24 may be provided as a single database or as separate databases, in whole or in part.

The first and second databases 22, 24 include first and second data structures 34, 36, respectively. The databases 22, 24 may be of any form which includes related data. The databases 22, 24 may be collections of data structures as one or more schema, tables, queries, reports, views and/or objects.

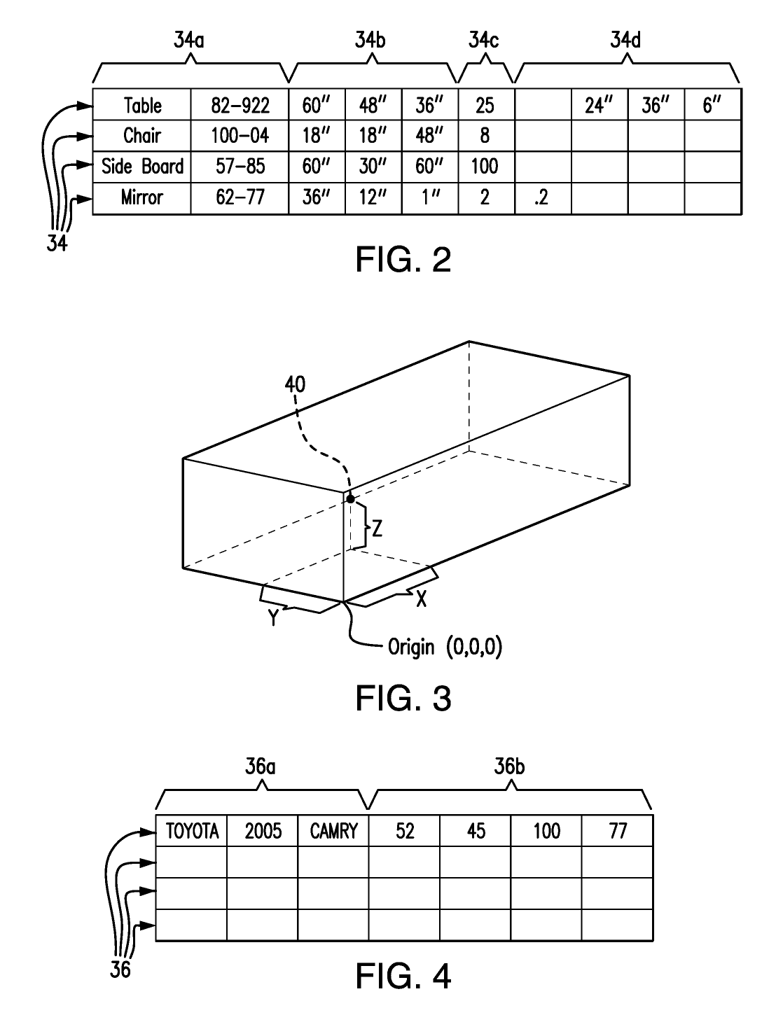

The first data structures 34 may include details of the one or more products 14 associated with details of the product(s) 14 in packaged states (packaged product(s) 38). As shown in FIG. 2, the first data structures 34 may include product listing fields 34a associated with packaged product dimension fields 34b (e.g., to represent, height, width and depth). The product listing fields 34a may be based on any identifier of the associated product(s) 14 including product name, catalogue number, SKU and so forth. The product listing fields 34a may be provided in parallel to varying extents to contain different product identifiers. This allows for a greater likelihood that a match will be found based on a search query. In response to a search query, and upon a match being determined with at least one of the product listing fields 34a, dimensions of the associated packaged product 38 may be extracted from the packaged product dimension fields 34b (e.g., height, width, depth). The first data structures 34 may include additional details relating to the product(s) 14 and/or the packaged product(s) 38. For example, a weight field 34c may be provided representing the weight of the associated packaged product 38. Also, one or more weight distribution fields 34d may be provided representing in some form how the weight of the associated packaged product 38 is distributed. For example, a weight by unit length (lbs/in, kg/cm) may be utilized in sections or across the associated packaged product 38. Also, Cartesian coordinates may be provided, based on units of length, to locate the associated packaged product's 38 center of gravity 40. The Cartesian coordinates may be provided based on an origin being considered to be located at a pre-defined location relative to the packaged product 38, e.g., a lower left corner of the packaged product 38. The Cartesian coordinates may provide x,y,z dimensions relative to an origin (0, 0, 0) to define in space the associated packaged product's 38 center of gravity 40 (FIG. 3). To varying extents, aforementioned details related to the packaged product(s) 38, e.g., certain dimensions, may be maintained in electronic files in an accessible library 42 or other non-transitory storage. Cross-referencing may be provided with the relevant first data structures 34, with appropriate links, to access relevant data from the library 42. The library 42 may contain electronic files of graphical depictions of some or all of the packaged product(s) 38.

The second data structures 36 may include details related to the at least one vehicle 16 intended for transporting the one or more packaged product(s) 38. The vehicle 16 may be in form suitable for transporting packaged products including being motor-driven (e.g., car, van, truck) and non-motor-driven (e.g., trailer). As shown in FIG. 4, the second data structures 36 may include vehicle identification fields 36a, such as make, model and year of vehicles, associated with relative dimensioning 36b. The dimensioning 36b may be provided in a standardized format so that extracted results may include a string of numbers which may be interpreted to correspond to particular: linear dimensions (e.g., single axis dimensions (height, width, depth in units of length)); area dimensions (in units of area (e.g., ft², m²)); and, volume dimensions (in units of volume (e.g., ft³, m³))), of particular parts/sections of the vehicle (e.g., back seat, trunk, roof). As such, multiple sets of dimensioning may be extracted. To varying extents, the library 42 may include aforementioned vehicle details in electronic files of vehicle drawings and/or vehicle dimensioning, cross-referenced with the relevant second data structures 36. The library 42 may be accessed based on the selection of the at least one vehicle 16 with extraction of corresponding drawings and/or vehicle dimensioning. The vehicle drawings may include graphical depictions of vehicles and used as discussed below.

The library 42 may be maintained on any non-transitory storage and located on one or over several devices on the network 27. The library 42 may be made integral as part of the first database 22 and/or the second database 24, or the library 42 may be separately provided and accessed as needed (e.g., by the central processing unit 26 and/or the at least one database management system 32).

The system 10 may be configured to accept a request by the consumer 12 to determine the packability of the at least one product 14 in the at least one vehicle 16 intended to transport the at least one product 14 in the state of the packaged product(s) 38. To initiate the system 10, the application software 29 may be initiated to generate the GUI 18 with the consumer 12 inputting details related to the at least one product 14 and the at least one vehicle 16 utilizing the GUI 18 using one or more input devices 44, including, but not limited to, touch screen displays, keyboards, keypads, touch pads, mice, and voice recognizers. The number of passengers intended for the at least one vehicle during transportation of the packaged product(s) 38 may be also inputted. The GUI 18 may be configured to accept one or more of: manually inputted details; details selected from pull-down menus or other selectable fields or buttons; and/or scannable or machine-readable codes, such as barcodes or QR codes scanned from a related symbol. The application software 29 may be caused to transmit inputted details automatically with the inputting of details into the GUI 18 or may be caused to transmit in response to manual input (e.g., the consumer 12 is requested to provide permission to transmit). The inputted details are transmitted to the central processing unit 26 over the network 27, where the computer instructions 28 are caused to be executed to have the central processing unit 26 generate and transmit search requests to the at least one database management system 32. In turn, the at least one database management system 32 executes one or more queries of the first and/or second databases 22, 24 based on the received search requests to determine if any of the first data structures 34 and/or the second data structures 36 match the inputted details of the queries. With finding matches, details are extracted from the corresponding first and/or second data structures 34, 36 and transmitted to the central processing unit 26 for further processing.

With the central processing unit 26 having the extracted details, the computer instructions 28 cause the central processing unit 26 to determine the packability of the packaged product(s) 38 relative to the at least one vehicle 16 used in the querying of the second database 24 and relative to the number of passengers intended to be therein. In particular, with further execution of the computer instructions 28, the central processing unit 26 yields one or more scenarios of arranging the packaged product(s) 38 relative to the at least one vehicle 16. The scenarios may include details as to how the packaged product(s) 38 may be arranged relative to the at least one vehicle 16, e.g., relative to any: interior spaces (front seat, back seat, across seats); storage spaces (e.g., trunk space); and/or, exterior surfaces suitable for supporting packaging (e.g., roof space). The one or more scenarios may be transmitted to the networkable device 20 for display on the screen 19, e.g., via the GUI 18, as a message to the consumer 12. The scenarios may be graphically displayed on the GUI 18 as the message showing the packaged product(s) superimposed against imagery of the at least one vehicle 16, such as imaging extracted from the library 42.

To determine packability, the computer instructions 28 may include volume and area computational techniques which allow for iterative comparative volume and area calculations of the packaged product(s) 38 relative to the at least one vehicle 16 taking the number of passengers into consideration. These calculations may compare the extent of overlap, or lack thereof, of boundaries of the packaged product(s) 38 in various volumes and areas of the at least one vehicle 16. A lack of overlap may be taken as an indicator of a possible packaging scenario. All dimensional and weight units must be the same for comparable processing. The units may be converted as necessary.

For graphical display, any solid, surface or volume modelling may be used which can generate geometric shapes and topography as needed, including, but not limited to, polygon mesh modeling, facet modeling, box modeling, constructive solid geometry modeling, boundary representation (b-rep), and geometric modeling. Modeling may be used to generate images as needed. In addition, or alternatively, stored renderings (e.g., stored in the library 42) may be utilized of the packaged product(s) 38 and the at least one vehicle 16. Based on determined packaging scenarios, the renderings of the packaged product(s) 38 may be superimposed over portions of renderings of the at least one vehicle 16 with the superimposed image being transmitted and displayed on the screen 19, e.g., via the GUI 18.

The packability determination by the central processing unit 26, as a result of the execution of the computer instructions 28, may also consider weight and/or weight distribution of the packaged product(s) 38. Here, the arrangement of the packaged product(s) 38 not only takes volumes and areas into consideration (e.g., determining how the volume(s) of the packaged product(s) 38 fit relative to spaces or surfaces of the at least one vehicle 16), but also considers how the weight or weight distribution relative to the spaces or surfaces of the at least one vehicle 16 and relative to each other affects packing. For example, a plurality of the packaged products 38 may be considered for packing relative to the at least one vehicle 16. As a result, stacking of the packaged products 38 within and/or atop spaces or surfaces may be considered. The integrity of the stacking may be affected by the weight and/or weight distribution of the packaged product(s) 38, particularly as considered with respect to the packaged products' 38 dimensioning. Thus, an arrangement of a stack may not be necessarily determined by weight of product alone. The heaviest packaged product 38 having relatively small dimensioning, as compared to the other packaged products 38, may not define the best base for a stack of the packaged products 38. The computer instructions 28 may include weight and/or weight distribution computational ability, e.g., in the solid, surface and/or volume modeling techniques which are utilized. In this manner, the computer instructions 28 may cause iterative computations to evaluate packability based on size and weight distribution.

The packability determination may conclude that alternative vehicles and/or number of passengers, beyond what was inputted, may be suitable, possibly better suited, for transporting the packaged product(s) 38. This may result from the intended at least one vehicle 16 not being suitable and/or this may result as alternative suggestions to the consumer 12. Thus, if the computer instructions 28 generates a null set (i.e., zero results) for possible scenarios to pack the packaged product(s) 38 relative to the at least one vehicle 16 with a specified number of passengers, the computer instructions 28 may seek to re-determine packability based on varying one or both of a suitable vehicle and/or the number of passengers. The resulting scenarios may include scenarios where the inputted vehicle 16 and the inputted number of passengers are fixed variables and further scenarios where the vehicle 16 and/or the number of passengers are varied. As a further option, delivery by the vendor or a third party may be offered as a further scenario.

The computer instructions 28 may be administered by various parties including by a vendor of the packaged product(s) 38 or a third-party administrator. With a vendor administering the computer instructions 28, the first database 22 may be also administered by the vendor and be inclusive of only the vendor's products. This limits the size of the first database 22. With a third-party administrator, the first database 22 may be a central database covering products of multiple vendors. Alternatively, a plurality of first databases 22 may be utilized administered by various parties, including individual vendors. With a plurality of the first databases 22, the central processing unit 26 may be associated with a look-up table 46 or other cross-reference source to allow for determining the location (including routing details) of the first database 22 associated with packaged product(s) 38 inputted through the GUI 18. The central processing unit 26 may route generated search requests to the database management system 32 associated with the proper first database 22 as needed.

The third-party administrator may be an electronic payment processor or facilitator. Thus, upon the determination of scenarios of the packaged product(s) 38 relative to the at least one vehicle 16, access may be provided to a payment portal 49, over the network 27, for accepting payment. A payment graphical user interface 48 may be provided on the screen 19, e.g., as a webpage or frame using a browser located on the networkable device 20, to allow for interfacing with the payment portal 49. The payment graphical user interface 48 may allow for the entry of payment details (credit card number, debit card number, account number, payment facilitator account number (e.g., PayPal)). In addition, the payment graphical user interface 48 may allow for access to one or more digital wallets which allow for payment through multiple associated forms of payment.

In addition, the computer instructions 28 may include instructions to provide access to sources for alternate vehicles, such as rental companies for renting cars, trucks, vans, and trailers. An alternate vehicle may be also considered an additional storage unit that may be mountable, or otherwise useable, with the inputted at least one vehicle 16, such as a roof-mounted rack or storage bin. The computer instructions 28 may provide one or more hyperlinks, e.g, on the GUI 18, which allow for access to associated IP addresses for sources for alternate vehicles.

The computer instructions 28 may be caused to execute at various times relative to a transaction related to the packaged product(s) 38. In one variation, the computer instructions 28 may be caused to be executed from one's home or other location remote from where the packaged product(s) 38 are intended to be picked-up. This can be the result of on-line shopping without the need to visit a “brick-and-mortar” store location. This allows for proactive planning where, in advance, one may determine if an intended vehicle will be suitable or if an alternate vehicle may be better suited and appropriate accommodations may be taken.

In a further variation, the consumer 12 may input into the GUI 18 details related to one or more products 14 while shopping, prior to check-out, to determine if an intended vehicle 16 will be suitable to transport the associated packaged product(s) 38. Once the consumer 12 completes shopping (i.e., selecting the products 14), GUI 18 may be configured to allow for requesting access to the payment portal 49 with the payment graphical user interface 48 being launched to allow for payment to be made over the networkable device 20, without the need to go through a standard check-out. A readable receipt may be generated, viewable over the GUI 18 and/or the payment graphical user interface 48, which facilitates pick-up of the associated packaged product(s) 38. The receipt may include a QR code or other machine-readable code to facilitate processing of the pick-up.

In yet a further variation, the instructions 28 may be caused to be initiated after check-out, even in a traditional manner. This allows for the consumer 12, prior to approaching pick-up, to evaluate feasibility of transporting the packaged product(s) 38.

As will be recognized by those skilled in the art, the instructions 28 may be configured to provide access to additional information related to the packaged product(s) 38, such as building instructions, lists of required tooling and/or hardware, etc. Hyperlinks or other modes of presentment may be displayed on the networkable device 20, e.g., via the GUI 18, offering services for assembling one or more of the packaged product(s) 38.

As used herein, the term “memory” is intended to include all currently known or hereafter developed types of permanent or temporary storage devices or components in a computing device. Exemplary memory types include, by way of illustration and not limitation, Random Access Memory (RAM)—further including Dynamic RAM (DRAM), Static RAM (SRAM), and Direct Rambus DRAM (DRDRAM), Read Only Memory (ROM)—further including Programmable ROM (PROM), erasable PROM (EPROM), and Electrically EPROM (EEPROM), cache memory, hard drives and flash memory. As used herein, the term “storage” is intended to include all currently known or hereafter developed types of permanent or temporary storage devices or components associated with a computing device. Exemplary storage types include, by way of illustration and not limitation, hard drives, external hard drives, solid state drives, tape drives, optical drives, flash memory, RAID storage, and USB storage. The terms “memory” and “storage” may be used interchangeably herein.

The application software 29 and the program of instructions 28, and any other program discussed herein configured to cause a processor to execute certain steps or processes, may be stored on a non-transitory computer-readable medium. As used herein, the term “computer-readable medium” means and includes, but is not limited to, solid-state memories such as a memory card or other package that houses one or more read-only (non-volatile) memories, random access memories, or other re-writable (volatile) memories; magneto-optical or optical medium such as a disk or tape; and/or a digital file attachment to e-mail or other self-contained information archive or set of archives that is considered a distribution medium equivalent to a tangible storage medium. Accordingly, the definition of “computer-readable medium” is considered to include anyone or more of a tangible computer-readable medium or a tangible distribution medium, as listed herein and including art-recognized equivalents and successor media, in which the software implementations herein are stored. The components of the system 10 may be considered to have or be associated with computer-readable medium, including, but not limited to, the networkable device 20, the central processing unit 26, the at least one database management system 32, and the payment portal 49.

What is claimed is:

1. A method of determining the packability of product contemplated for purchase with respect to a vehicle intended for transporting the contemplated product, the method comprising:
receiving, by a computer processor, one or more selections of the contemplated product, the vehicle intended for transporting the contemplated product, and number of passengers under consideration to be in the intended vehicle while transporting the contemplated product;
extracting from a first database, first data regarding size of packaging associated with the contemplated product;
extracting from a second database, second data regarding dimensioning of the intended vehicle;
executing instructions stored in a non-transitory memory, wherein the execution of the instructions calculates the packability of the contemplated product in the associated packaging with respect to the intended vehicle based on the first data, the second data, and the number of passengers under consideration to be in the intended vehicle while transporting the contemplated product, wherein, the execution of the instructions further selectively yields one or more scenarios of arranging the contemplated product in the associated packaging relative to the intended vehicle and relative to the number of passengers under consideration to be in the intended vehicle while transporting the contemplated product; and,
displaying a message selectively conveying the one or more scenarios.

2. A method as in claim 1, wherein details related to the contemplated product may be inputted into a networkable device operatively linked to the computer processor over a network.

3. A method as in claim 2, wherein application software associated with the networkable device is configured to transmit the details to the computer processor over the network.

4. A method as in claim 1, wherein the packability is calculated based on comparative volume calculations of the contemplated product relative to the vehicle intended for transporting the contemplated product in view of the number of passengers under consideration to be in the intended vehicle while transporting the contemplated product.

5. A method as in claim 1, wherein the packability is calculated based on comparative area calculations of the contemplated product relative to the vehicle intended for transporting the contemplated product in view of the number of passengers under consideration to be in the intended vehicle while transporting the contemplated product.

6. A method as in claim 1, wherein the message includes imagery of the contemplated product superimposed over imagery of the vehicle intended for transporting the contemplated product.

7. A method as in claim 1, further comprising providing access to a payment portal.

8. A non-transitory computer-readable medium storing computer-readable instructions for determining the packability of product contemplated for purchase with respect to a vehicle intended for transporting the contemplated product based on one or more selections of the contemplated product, the vehicle intended for transporting the contemplated product, and number of passengers under consideration to be in the intended vehicle while transporting the contemplated product, that, when executed, the instructions cause a processor to:
create a request to extract from a first database, first data regarding size of packaging associated with the contemplated product;
create a request to extract from a second database, second data regarding dimensioning of the intended vehicle;
calculate the packability of the contemplated product in the associated packaging with respect to the intended vehicle based on the first data, the second data, and the number of passengers under consideration to be in the intended vehicle while transporting the contemplated product to selectively yield one or more scenarios of arranging the contemplated product in the associated packaging relative to the intended vehicle and relative to the number of passengers under consideration to be in the intended vehicle while transporting the contemplated product; and,
transmit a message selectively conveying the one or more scenarios.

9. A method of determining the packability of product contemplated for purchase with respect to a vehicle intended for transporting the contemplated product, the method comprising:
receiving, by a computer processor, one or more selections of the contemplated product, the vehicle intended for transporting the contemplated product, and number of passengers under consideration to be in the intended vehicle while transporting the contemplated product;
extracting from a first database, first data regarding size of packaging associated with the contemplated product;
extracting from a second database, second data regarding dimensioning of the intended vehicle;
executing instructions stored in a non-transitory memory, wherein the execution of the instructions calculates the packability of the contemplated product in the associated packaging with respect to the intended vehicle based on the first data, the second data, and the number of passengers under consideration to be in the intended vehicle while transporting the contemplated product, wherein, the execution of the instructions further selectively yields: 1. one or more scenarios of arranging the contemplated product in the associated packaging relative to the intended vehicle and relative to the number of passengers under consideration to be in the intended vehicle while transporting the contemplated product; and, 2. one or more alternate scenarios for transporting the contemplated product in the associated packaging based on one or more of: a number of passengers other than the number of passengers under consideration to be in the intended vehicle, and, one or more vehicles other than the intended vehicle; and,
displaying a message selectively conveying the one or more scenarios and the one or more alternate scenarios.

10. A method as in claim 9, wherein details related to the contemplated product may be inputted into a networkable device operatively linked to the computer processor over a network.

11. A method as in claim 10, wherein application software associated with the networkable device is configured to transmit the details to the computer processor over the network.

12. A method as in claim 9, wherein the packability is calculated based on comparative volume calculations of the contemplated product relative to the vehicle intended for transporting the contemplated product in view of the number of passengers under consideration to be in the intended vehicle while transporting the contemplated product.

13. A method as in claim 9, wherein the packability is calculated based on comparative area calculations of the contemplated product relative to the vehicle intended for transporting the contemplated product in view of the number of passengers under consideration to be in the intended vehicle while transporting the contemplated product.

14. A method as in claim 9, wherein the message includes imagery of the contemplated product superimposed over imagery of the vehicle intended for transporting the contemplated product.

15. A method as in claim 9, further comprising providing access to a payment portal.

16. A non-transitory computer-readable medium storing computer-readable instructions for determining the packability of product contemplated for purchase with respect to a vehicle intended for transporting the contemplated product based on one or more selections of the contemplated product, the vehicle intended for transporting the contemplated product, and number of passengers under consideration to be in the intended vehicle while transporting the contemplated product, that, when executed, the instructions cause a processor to:
create a request to extract from a first database, first data regarding size of packaging associated with the contemplated product;
create a request to extract from a second database, second data regarding dimensioning of the intended vehicle;
calculate the packability of the contemplated product in the associated packaging with respect to the intended vehicle based on the first data, the second data, and the number of passengers under consideration to be in the intended vehicle while transporting the contemplated product to selectively yield: 1. one or more scenarios of arranging the contemplated product in the associated packaging relative to the intended vehicle and relative to the number of passengers under consideration to be in the intended vehicle while transporting the contemplated product; and, 2. one or more alternate scenarios for transporting the contemplated product in the associated packaging based on one or more of: a number of passengers other than the number of passengers under consideration to be in the intended vehicle, and, one or more vehicles other than the intended vehicle; and,
transmit a message selectively conveying the one or more scenarios.
